(19) United States
(12) Patent Application Publication
(10) Pub. No.: US 2018/0313340 A1
(43) Pub. Date: Nov. 1, 2018

(54) ORC BINARY CYCLE GEOTHERMAL PLANT AND PROCESS

(71) Applicant: EXERGY S.P.A., Bologna (IT)

(72) Inventors: Claudio SPADACINI, Verbania Suna (IT); Dario RIZZI, Bisuschio (IT); Luca Giancarlo XODO, Grezzago (IT)

(73) Assignee: EXERGY S.P.A., Bologna (IT)

(21) Appl. No.: 15/769,319

(22) PCT Filed: Oct. 24, 2016
(86) PCT No.: PCT/IB2016/056377

§ 371 Date: Apr. 18, 2018

(30) Foreign Application Priority Data
Oct. 26, 2015 (IT) 102015000065338

(51) Int. Cl. F03G 7/04; F01K 21/00

(52) U.S. Cl. CPC F03G 7/04; F01K 21/005

(57) ABSTRACT

An ORC binary cycle geothermal plant, including at least one ORC closed-cycle system and a geothermal system. The geothermal system includes at least one intake line of a geothermal fluid connected to at least one geothermal production well, wherein the fluid includes non-condensable gases; one interface line connected to the intake line, coupled to the ORC system in an interface zone, wherein the fluid exchanges heat with the organic working fluid; one reinjection line connected to the interface line and to at least one geothermal reinjection well. Further at least one separator device configured to separate at least the gases from the fluid; one expander connected to an outlet of the gases by the separator device; and one auxiliary generator connected to the expander. The expander is for interfacing with the system to receive and expand at least the gases after they have exchanged heat with the organic working fluid.

### FIELD OF THE INVENTION

The present invention relates to an ORC binary cycle geothermal plant and process (Organic Rankine Cycle). An ORC binary cycle geothermal plant/process is a plant/process for generating electricity/power (power station) which exploits geothermal sources using a secondary fluid to which the hot geothermal fluid transfers heat in heat exchangers. The secondary fluid is an organic fluid used in an ORC closed cycle which is heated, evaporates and expands in a turbine before being condensed and pumped back to the heat exchangers in order to start the closed cycle again. This configuration enables energy to be produced from sources with a lower enthalpy level compared to systems which directly exploit geothermal vapour in turbines (direct dry steam expansion systems or flash systems), or makes it possible to increase plant efficiency in combination with direct exploitation technologies.

### BACKGROUND OF THE INVENTION

A geothermal system is generally made up of one or more wells, a system for collecting one or more liquid or two-phase flows and in some cases a system for separating and distributing liquid flows on the one hand and flows made up of a mixture of vapour and non-condensable gases (NCGs) on the other hand. NCGs are almost totally made up of carbon dioxide CO₂ (e.g. 70%-98%) and hydrogen sulphide H₂S (e.g. 0.6%-24%), and to a small extent of other gases (e.g. nitrogen N₂, hydrogen H₂ and methane CH₄).

There are known ORC binary cycle geothermal plants which supply both the liquid flows and flows made up of the mixture of vapour and non-condensable gases (NCGs) into one or more exchangers, where they exchange heat with an organic working fluid of the ORC cycle.

For example, public document WO2014041417 (also published as US2014075938A1) illustrates a method and an apparatus for producing power from a geothermal fluid. The method comprises: separating, in a separating device, the geothermal fluid coming from a geothermal production well into geothermal vapour and non-condensable gases (NCGs) and geothermal brine, supplying the geothermal vapour and the non-condensable gases (NCGs) to a vaporizer; vaporizing a preheated organic working fluid vaporizer using the heat from the geothermal vapour to produce partially condensed geothermal vapour and vaporised organic fluid; expanding the vaporised organic fluid in a turbine producing power and expanded vaporised organic fluid; condensing the expanded vaporised organic fluid in a condenser to produce condensed organic fluid; preheating the condensed organic fluid in a preheater using heat from the condensed geothermal vapour and the geothermal brine. In some embodiments illustrated in that document, before passing through the vaporizer, the geothermal vapour and the non-condensable gases (NCGs) are expanded in an expander connected to the generator associated with the turbine and, after passing through the vaporizer, the non-condensable gases (NCGs) are compressed in a compressor and re-injected into a geothermal injection well together with the geothermal brine from the preheater.

Public document WO2014/140756 illustrates a binary geothermal plant for the production of power. The plant comprises an ORC system, a separator device for separating the geothermal fluid into a vapour phase portion with non-condensable gases (NCGs) and a brine portion which operate in conjunction with the ORC system and a system for preventing the loss of efficiency of the heat exchangers due to the precipitation of solids contained in the geothermal brine. The vapour phase portion and brine portion exiting the separator device pass into a vaporizer of the ORC system to vaporise the organic working fluid, and subsequently into a second separator device configured to separate the NCGs from the steam condensate. The NCGs are sent to a mixing unit (which is part of the system for preventing the loss of efficiency of the heat exchangers) via a compressor, together with the steam condensate and geothermal brine. The geothermal fluid reconstructed in the mixing unit is delivered to a preheater of the ORC system and then introduced into a reinjection well. In one embodiment illustrated in that document, before passing into the vaporizer of the ORC system, the vapour phase portion with non-condensable gases (NCGs) exiting the separator device is supplied to a steam turbine so as to produce additional power by means of a generator.

In both of the documents illustrated above, the mixture of geothermal vapour and non-condensable gases (NCGs) is supplied directly by the separator device to the expander, in which the mixture expands until reaching a certain pressure before being supplied to the ORC binary cycle.

### SUMMARY

In this area, the Applicant has perceived a need to improve the efficiency of binary plants as a whole, for example to produce more power, the available geothermal resource being equal.

The Applicant has in particular perceived the need to improve the exploitation of non-condensable gases (NCGs) within ORC binary plants.

The Applicant has also perceived the need to structurally simplify and reduce the production and/or maintenance costs of ORC binary plants which, like the known ones described above, exploit the non-condensable gases (NCGs) in an expander.

In particular, the Applicant has set itself the following objectives:
to conceive an ORC binary process and plant that are more efficient in exploiting geothermal resources;
to conceive an ORC binary process and plant for exploiting geothermal resources which enable better use of the non-condensable gases (NCGs) contained in the geothermal resource;
to conceive an ORC binary process and plant for exploiting geothermal resources which enable such exploitation irrespective of the geothermal resource (whose variability is neither foreseeable nor controllable), in particular, in a manner almost independent of the composition of said NCGs;
to conceive an ORC binary process and plant for exploiting geothermal resources which may be better adapted to the exploitation of NCGs in terms of the structural strength and wear of the parts interacting with said gas;
to conceive an ORC binary process and plant for exploiting the geothermal resources which enable a controlled, safe management of NCGs also after they have been exploited within the cycle;
to conceive an ORC binary process and plant for exploiting geothermal resources which are structurally simple, in particular as regards the part of the plant dedicated to the expansion of NCGs.

The Applicant has observed that downstream of a first cooling of the geothermal mixture, comprising geothermal vapour and non-condensable gases (NCGs), used to supply an ORC binary cycle (i.e. at the outlet of the exchangers connected to the ORC), there will be a geothermal mixture from which a good part of the exploitable heat has been extracted, reducing the temperature thereof and condensing the vapour, but which is still at a pressure not dissimilar from the inlet pressure, thanks to the reduced pressure drop relative to the inlet.

The Applicant has realized that by expanding said geothermal mixture after said first cooling (i.e. at the outlet of the exchangers connected to the ORC), it is possible to have the expander work with much more modest enthalpy changes than those typical of NCG expanders of the above-mentioned prior art, which in contrast receive the mixture coming directly from the geothermal well (separated from the geothermal brine) and thus containing all of the exploitable heat. This is due to the fact that, after the heat exchange in the binary cycle, the geothermal mixture entering the expander has a very high percentage of NCGs (typically 50-70%, but more generally comprised between 30 and 95%) and a small percentage of steam, as well as a generally lower temperature.

This makes it possible to adopt an expander with a discharge at atmospheric pressure without losses of efficiency. In contrast, the prior art solutions, such as those described above, normally have a discharge under vacuum, since, if it were at atmospheric pressure, a large amount of steam would be lost in the atmosphere, which would greatly impair efficiency.

The expander can also be more compact and structurally simpler and more economical, since the reduced enthalpy change makes many expander stages unnecessary. As it is compact, high quality, corrosion-resistant materials can be used for its construction, such as stainless steel (for example with a % Cr greater than 16%), or titanium or nickel alloys.

It should be noted that the above-cited document WO2014041417 (US2014075938A1) does not enable such objectives to be achieved because the NCG expanders of WO2014041417 receive the mixture coming directly from the geothermal well (separated from the geothermal brine) and therefore containing all the exploitable heat. In order not to lose steam into the atmosphere, which would greatly impair efficiency, WO2014041417 envisages re-injecting part of the NCGs underground after having compressed them and exploited them in the cooling tower and in the condenser, which renders the plant complex and costly. In contrast, as already pointed out, by expanding the geothermal mixture after a first reduction in enthalpy thanks to the cooling and the reduction in steam content, i.e. at the outlet of the exchangers connected to the ORC, it is possible to have the expander work with much more modest enthalpy changes than those typical of NCG expanders of the above-mentioned prior art; this allows the adoption of an expander with a discharge at atmospheric pressure without losses of efficiency. Not only does WO2014041417 not enable such objectives to be achieved, but it also suggests an opposite solution.

The Applicant has thus found that the above-mentioned objectives and still others can be reached by implementing in the ORC binary cycle geothermal plant one or more expanders located downstream of the exchangers connected to the ORC in which to convey and expand the non-condensable gases (NCGs), possibly together with the geothermal vapour coming from said exchangers.

In particular, the specified objectives and still others are substantially reached by a plant and an ORC binary geothermal process of the type claimed in the appended claims and/or disclosed in the following aspects.

In an independent aspect, the present invention relates to an ORC binary cycle geothermal plant, comprising at least one ORC closed-cycle system comprising at least: one vaporizer; one expansion turbine; one generator operatively connected to the expansion turbine (so as to generate electricity/power); one condenser; one pump; and ducts configured to connect the vaporizer, the expansion turbine, the condenser and the pump according to a closed cycle in which an organic working fluid circulates. The ORC binary cycle geothermal plant further comprises a geothermal system comprising at least: one geothermal fluid intake line connected to at least one geothermal production well, wherein the geothermal fluid comprises non-condensable gases; one interface line connected to the intake line and operatively coupled to said at least one ORC closed-cycle system in an interface zone, wherein the geothermal fluid exchanges heat with the organic working fluid of said ORC closed-cycle system; and one reinjection outlet line connected to the reinjection interface line. The geothermal system further comprises: at least one separator device configured to separate at least the non-condensable gases from the geothermal fluid; one expander operatively connected to an outlet for the non-condensable gases exiting the separator device; and one auxiliary generator operatively connected to the expander (so as to generate additional electricity/power). The expander is located downstream of the interface zone, where it interfaces with the ORC closed-cycle system so as to receive and expand at least the non-condensable gases after they have exchanged heat with the organic working fluid. Preferably, the outlet line is a reinjection line connected to a geothermal reinjection well. Alternatively, the outlet line discharges into the open air.

In an independent aspect, the present invention relates to an ORC binary cycle geothermal process, comprising: circulating an organic working fluid in an organic Rankine cycle, wherein said organic working fluid is heated and vaporized, expanded in a turbine connected to a generator, condensed and again heated and vaporized; extracting a geothermal fluid comprising non-condensable gases from a geothermal production well, operatively coupling the geothermal fluid to the organic working fluid of the organic Rankine cycle in order to exchange heat with said organic working fluid, heating and vaporizing said organic working fluid, and discharging the geothermal fluid;

wherein the process further comprises: separating at least the non-condensable gases from the geothermal fluid, expanding said non-condensable gases in an expander connected to an auxiliary generator;
wherein the expansion of the non-condensable gases in the expander is carried out after said non-condensable gases have exchanged heat with the organic working fluid.

In one aspect in accordance with the preceding aspects, the expander receives and expands a geothermal mixture comprising geothermal vapour and the non-condensable gases. Preferably, discharging the geothermal fluid comprises: reinjecting the geothermal fluid into a geothermal reinjection well. Alternatively, discharging the geothermal fluid comprises: discharging into the open air.

The Applicant has verified that with typical CO₂ (NCG) concentrations of 50-70% (obtainable by positioning the expander according to the present invention) and discharge at atmospheric pressure, the partial discharge pressure of the vapour will be about 30-50% and thus the expander discharge temperature, at atmospheric pressure, will correspond to a saturated pressure of about 0.3-0.5 bar, i.e. 50-80° C. It is thus demonstrated that little energy is lost in the atmosphere. If the percentage of CO₂ (NCG) were only 5-10%, as in the case of the prior art solutions, many tons of steam would be lost in the atmosphere at about 95-99° C., which would greatly impair efficiency.

The Applicant has further verified that the modest enthalpy change can be managed with relatively simple, compact expanders.

The Applicant has also observed that the conditions of the geothermal resource are highly variable. The geothermal mixture that passes through the expander can contain, in addition to the NCGs, solid particles and liquid particles (drops of H₂O, moisture of the mixture). These particles have an erosive effect on the parts of the expander they come into contact with. The erosive effect is directly proportional to the velocity of the fluid itself. Furthermore, the erosion is greater in expanders in which the field of centrifugal forces gathers together the particles with a higher density (be they solid or liquid) in limited areas, thus increasing this effect.

The Applicant has realized that preference should be given to expanders in which the fluid velocities, both absolute and relative, are low and in which the centrifugal forces are uninfluential. The Applicant has found that centrifugal radial turbines, single- or counter-rotating, are perfectly suited to use with geothermal mixtures because they are better able to resist the corrosive agents of the latter.

Therefore, in a further independent aspect, the present invention relates to an ORC binary cycle geothermal plant, comprising at least one ORC closed-cycle system comprising at least: one vaporizer; one expansion turbine; one generator operatively connected to the expansion turbine; one condenser; and ducts configured to connect the vaporizer, the expansion turbine and the condenser according to a closed cycle in which an organic working fluid circulates. The ORC binary cycle geothermal plant further comprises a geothermal system comprising at least: one geothermal fluid intake line connected to at least one geothermal production well, wherein the geothermal fluid comprises non-condensable gases; one interface line connected to the intake line and operatively coupled to said at least one ORC closed-cycle system in an interface zone, wherein the geothermal fluid exchanges heat with the organic working fluid of said ORC closed-cycle system; and one reinjection line outlet connected to the reinjection interface line. The geothermal system further comprises: at least one separator device configured to separate at least the non-condensable gases from the geothermal fluid; one expander operatively connected to an outlet for the non-condensable gases exiting the separator device; and one auxiliary generator operatively connected to the expander. The expander for the non-condensable gases is a centrifugal radial (outflow) turbine, preferably of the counter-rotating type. Preferably, the outlet line is a reinjection line connected to a geothermal reinjection well. Alternatively, the outlet line discharges into the open air.

The term “interface zone” means the set of devices (e.g. vaporizers, preheaters) in which the geothermal fluid and the organic working fluid exchange heat.

In one aspect in accordance with one or more of the preceding aspects, said at least one separator device is configured to separate the geothermal fluid into geothermal brine and a geothermal mixture comprising geothermal vapour and non-condensable gases.

In one aspect in accordance with the preceding aspect, said at least one separator device has an inlet for the geothermal fluid, a first outlet for the geothermal mixture and a second outlet for the geothermal brine.

In one aspect in accordance with the preceding aspect, the expander is connected to the first outlet of said at least one separator device so as to receive and expand the geothermal mixture comprising geothermal vapour and the non-condensable gases.

In one aspect in accordance with one or more of the preceding aspects, said at least one separator device is also located downstream of the interface zone. The separation is carried out after the geothermal mixture has exchanged heat with the ORC cycle and, on exiting the separator device, the geothermal vapour and the non-condensable gases are introduced into the expander.

In one aspect, according to a variant embodiment, said at least one separator device is located upstream of the interface zone. The separation is carried out before the geothermal mixture exchanges heat with the ORC cycle and, on exiting the exchanger situated in the interface zone, the geothermal vapour and the non-condensable gases are introduced into the expander.

In one aspect, according to a further variant embodiment, said at least one separator device comprises a first separator device positioned upstream of the interface zone and a second separator device positioned downstream of the interface zone. The second separator device separates the liquid part of the geothermal mixture exiting the exchanger situated in the interface zone from the geothermal vapour with non-condensable gases.

In one aspect in accordance with the preceding aspects, the geothermal plant comprises a high pressure ORC closed-cycle system and a low pressure ORC closed-cycle system positioned operatively downstream of the high pressure ORC closed-cycle system.

In one aspect in accordance with the preceding aspect, an interface zone of the low pressure ORC closed-cycle system receives the geothermal fluid after said geothermal fluid has exchanged heat in the interface zone of the high pressure ORC closed-cycle system.

In one aspect in accordance with the preceding aspect, the expander is located downstream of the interface zone of the low pressure ORC closed-cycle system and/or of the interface zone of the high pressure ORC closed-cycle system.

In one aspect in accordance with the preceding aspect, said at least one separator device is located operatively downstream of the interface zone of the low pressure ORC closed-cycle system and/or of the interface zone of the high pressure ORC closed-cycle system.

In one aspect according to at least one of the preceding aspects, the interface line comprises at least one first line operatively coupled to the vaporizer of the ORC closed-cycle system, wherein, in said vaporizer, the geothermal mixture flowing in said first line exchanges heat with the organic working fluid for vaporizing said organic working fluid.

In one aspect according to the preceding aspect, the ORC closed-cycle system comprises a preheater located in the interface zone.

In one aspect according to the preceding aspect, the interface line comprises at least one second line operatively coupled to the preheater of the ORC closed-cycle system, wherein, in said preheater, the geothermal fluid flowing in said second line exchanges heat with the organic working fluid so as to preheat said organic working fluid before entering the vaporizer.

In one aspect in accordance with the preceding aspect, the first separator device is positioned upstream of the interface zone and is configured to separate the geothermal fluid into geothermal brine and a geothermal mixture comprising geothermal vapour and non-condensable gases.

In one aspect in accordance with the preceding aspect, the first separator device has an inlet for the geothermal fluid, a first outlet for the geothermal mixture connected to the first line, and a second outlet for the geothermal brine connected to the second line.

In one aspect in accordance with the preceding aspect, a second separator device is positioned downstream of the interface zone and is configured to separate the geothermal mixture into condensed geothermal vapour and non-condensable gases.

In one aspect in accordance with the preceding aspect, the second separator device has an inlet for the geothermal mixture, a first outlet for the condensed geothermal vapour and a second outlet for the non-condensable gases connected to the expander.

In one aspect according to at least one of the preceding aspects, said at least one separator device comprises at least one direct contact heat exchanger and/or at least one surface-type heat exchanger.

In one aspect according to at least one of the preceding aspects, an inlet pressure of the expander is comprised between about 2 bar and about 16 bar.

In one aspect according to at least one of the preceding aspects, a discharge pressure of the expander is comprised between about 0.8 and about 1.3 bar. The discharge pressure is substantially equal to atmospheric pressure.

In one aspect according to at least one of the preceding aspects, an inlet temperature of the expander is comprised between about 90° C. and about 160° C.

In one aspect according to at least one of the preceding aspects, an enthalpy change through the expander is comprised between about 80 kJ/kg-K and about 200 kJ/kg-K. As pointed out previously, the modest enthalpy change can be managed with relatively simple, compact expanders.

In one aspect according to at least one of the preceding aspects, a percentage of non-condensable gases in the expander is comprised between about 30% and about 95% of the mass flow.

In one aspect according to at least one of the preceding aspects, a percentage of water in the expander is comprised between about 2% and about 25% of the mass flow. The steam lost in the atmosphere is minimal and this contributes to keeping efficiency high.

In one aspect according to at least one of the preceding aspects, an inlet mass flow rate of the expander is comprised between about 6 Kg/s and about 20 Kg/s.

In one aspect according to at least one of the preceding aspects, an inlet volumetric flow rate of the expander is comprised between about 0.4 m³/s and about 2.5 m³/s.

In one aspect according to at least one of the preceding aspects, a discharge volumetric flow rate of the expander is comprised between about 3 m³/s and about 15 m³/s.

In one aspect according to at least one of the preceding aspects, a discharge titer of the expander is comprised between about 85% and about 100%.

In one aspect according to at least one of the preceding aspects, a power generated by the auxiliary generator is comprised between about 500 kW and about 4000 kW.

In one aspect according to at least one of the preceding aspects, the expander is a centrifugal radial turbine.

In one aspect according to at least one of the preceding aspects, the expander is a single-rotating or counter-rotating centrifugal radial turbine.

In one aspect according to at least one of the preceding aspects, the expander is a multi-stage counter-rotating centrifugal radial turbine.

In one aspect according to at least one of the preceding aspects, the expander is a centrifugal radial turbine comprising: a fixed casing; a supporting disk having a face bearing at least one radial rotor stage made up of a series of blades disposed in succession along a respective circular path; a rotation shaft integral with the respective disk; at least one radial stator stage that is fixed relative to the casing and made up of a series of blades disposed in succession along a respective circular path and in a radially internal position relative to said at least one radial rotor stage;

wherein an expansion volume is delimited between the supporting disk and the casing; wherein said at least one disk has admission channels located in a radially internal position relative to said at least one radial rotor stage; wherein said at least one disk is free to rotate together with the respective shaft about a rotation axis under the action of the working fluid entering through the admission channels. In one aspect according to at least one of the preceding aspects, the expander is a counter-rotating centrifugal radial turbine, comprising: a first supporting disk having a first face bearing at least one radial rotor stage made up of a series of blades disposed in succession along a respective circular path and with a first orientation; a first rotation shaft integral with the first disk; a second supporting disk having a second face bearing at least one radial rotor stage made up of a series of blades disposed in succession along a respective circular path and with a second orientation, opposite the first; a second rotation shaft integral with the second disk; wherein the first disk is facing the second disk so as to delimit an expansion volume and the blades of the first disk are radially alternated with the blades of the second disk;
wherein each of the disks has admission channels located in a radially internal position relative to the series of blades of the radial rotor stages; wherein the first and the second disk are free to rotate together with the respective shafts about a common rotation axis and rotate in opposite directions under the action of a working fluid entering through the admission channels.

In one aspect according to at least one of the five preceding aspects, during operation the centrifugal radial turbine rotates with an angular velocity comprised between about 2000 RPM and about 4000 RPM.

In one aspect according to at least one of the preceding aspects, the auxiliary generator is directly connected to a shaft of the expander, without the interposition of any reduction gear. This is made possible by the number of revolutions at which the expander itself operates.

In one aspect according to at least one of the preceding aspects, the expander comprises a sealing device operatively disposed about a rotation shaft of said expander and configured to prevent the leakage of the non-condensable gases or of the geothermal vapour with non-condensable gases towards said shaft.

In an independent aspect, the present invention also relates to an expander, preferably a single- or counter-rotating centrifugal radial turbine, comprising at least one rotor and at least one rotation shaft, further comprising at least one sealing device operatively disposed about said at least one rotation shaft of said expander and configured to prevent the leakage of gas/steam towards said shaft.

In one aspect according to one of the two preceding aspects, said sealing device comprises: at least three sealing elements delimiting at least two annular chambers disposed about the rotation shaft; and at least one ejector operatively connected to said two annular chambers.

In one aspect according to the preceding aspect, the ejector comprises a motive fluid inlet, a nozzle connected to the motive fluid inlet, a suction inlet, and a diffuser; wherein a first annular chamber set in proximity to an expansion volume of the expander is in fluid communication with the motive fluid inlet of the ejector and wherein a second annular chamber adjacent to the outside environment is in fluid communication with the suction inlet of the ejector.

The ejector generates a pressure lower than atmospheric pressure in the second annular chamber, exploiting the gases (non-condensable gases or the geothermal vapour with non-condensable gases) present in the expander. In particular, the ejector exploits, as a motive fluid, the gases (non-condensable gases or the geothermal vapour with non-condensable gases) leaked by a first seal (and present in the first annular chamber) in order to draw in a mixture of the gases (non-condensable gases or geothermal vapour with non-condensable gases) present, together with the air that has entered from the outside environment, into the second annular chamber.

In one aspect according to the preceding aspect, the diffuser of the ejector is in fluid communication with a discharge outlet of the expander.

In one aspect according to the preceding aspect, the sealing device comprises at least a third annular chamber interposed between the first annular chamber and the second annular chamber and in fluid communication with the discharge outlet of the expander. In this manner it is possible to improve tightness, thus limiting the amount of non-condensable gases sucked in by the ejector into the mixture of air and non-condensable gases present in the second chamber.

In one aspect according to one of the preceding four aspects, the sealing device comprises an auxiliary annular chamber set between the second chamber and the outside environment, wherein said auxiliary chamber can be selectively placed in fluid communication with a source of gas (e.g. air) under pressure.

In one aspect according to the preceding aspect, the sealing device is configured to operate under two conditions: if the motive fluid (non-condensable gases) of the ejector is at a pressure such as to be able to create negative pressure in the second chamber, the auxiliary chamber will be disconnected from the source of gas under pressure; if the motive fluid (non-condensable gases) of the ejector is at a pressure such as not to be able to create negative pressure in the second chamber, the auxiliary chamber will be connected to the source of gas under pressure and the auxiliary chamber will be at a pressure higher than atmospheric pressure.

This solution allows to assure tightness even in the expander start-up phases (for reaching full rotation speed and loading), during which the pressures inside the expander can be such as not to ensure negative pressure in the second chamber.

### DESCRIPTION OF THE DRAWINGS

This description will be given below with reference to the attached drawings, provided solely for illustrative and therefore non-limiting purposes, in which:

FIG. 1 illustrates a binary cycle geothermal plant in accordance with the present invention;

FIG. 2 illustrates the plant of FIG. 1, which is also representative of other plants according to the present invention, with a schematically illustrated portion thereof;

FIG. 3 illustrates a variant embodiment of the plant of FIGS. 1 and 2;

FIG. 4 illustrates a further variant embodiment of the plant of FIG. 2;

FIG. 5 illustrates a further variant embodiment of the plant of FIG. 2;

FIG. 6 illustrates a sectional view of an expander usable in the plants of the preceding figures;

FIG. 7 schematically represents an element of the expander of FIG. 6;

FIG. 8 is a schematic representation of an expander usable in the plants of the preceding figures associated with the element of FIG. 7;

FIG. 9 schematically represents a variant of the element of FIG. 7;

FIG. 10 is a schematic representation of an expander usable in the plants of the preceding figures associated with the element of FIG. 9;

FIG. 11 illustrates an enlarged detail of the expanders of FIGS. 8 and 10;

FIGS. 12 and 13 schematically represent a further variant of the element of FIG. 7 in respective operating configurations;

FIG. 14 is a schematic representation of an expander usable in the plants of the preceding figure associated with the element of FIGS. 11 and 12;

FIGS. 15 and 16 are likewise schematic representations of variants of the expander of FIG. 14.

### DETAILED DESCRIPTION

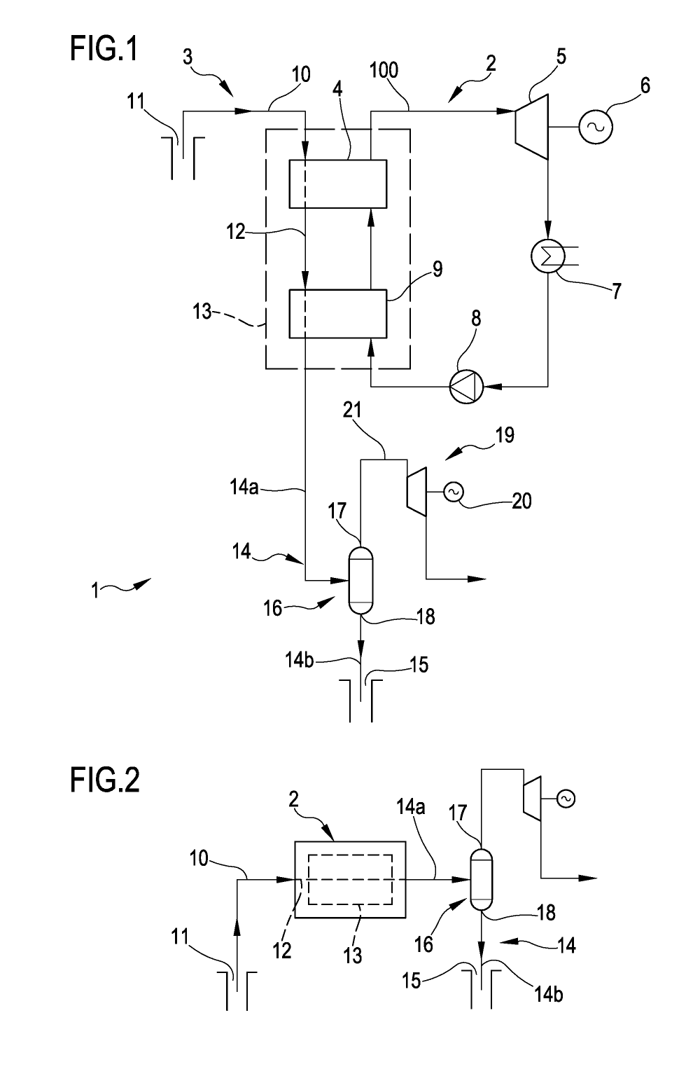

With reference to the aforesaid figures, the reference number 1 denotes in its entirety an ORC binary cycle geothermal plant. With particular reference to FIG. 1, the plant 1 comprises an ORC closed-cycle system (Organic Rankine Cycle) 2 and a geothermal system 3.

The ORC closed-cycle system 2 comprises: a vaporizer 4, an expansion turbine 5, a generator 6 operatively connected to the expansion turbine 5, a condenser 7, a pump 8, and a preheater 9. Ducts 100 connect the vaporizer 4, the expansion turbine 5, the condenser 7, the pump 8 and the preheater 9 according to a closed cycle. A high molecular weight organic working fluid OWF is circulated in the closed cycle. The organic working fluid OWF is preheated, heated and vaporized in the preheater 9 and in the vaporizer 4. The organic working fluid OWF in the vapour state exiting the vaporizer 4 enters the expansion turbine 5, where it expands, causing the rotation of the rotor(s) of the expansion turbine 5 and of the generator 6, which thus generates electricity. The expanded organic working fluid OWF subsequently enters the condenser 7, where it is brought back to the liquid phase and from here pumped by the pump 8 back into the preheater 9.

The heating and vaporization of the organic working fluid OWF take place by virtue of a heat exchange with a geothermal fluid GF coming from the geothermal system 3.

The geothermal system 3 comprises an intake line 10 for the geothermal fluid GF connected to a geothermal production well 11, an interface line 12 connected to the intake line 10 and operatively coupled to the ORC closed-cycle system 2 in an interface zone 13 and an outlet line consisting of a reinjection line 14 connected to the interface line 12 and to at least one geothermal reinjection well 15. In the embodiment in FIG. 1, the interface zone 13 comprises the vaporizer 4 and the preheater 9. More in general, in the present description and in the appended claims, the term “interface zone” 13 means the set of devices (e.g. vaporizers, preheaters) in which the geothermal fluid GF and the organic working fluid OWF exchange heat. The ORC closed-cycle system 2 and interface zone 13 are schematically illustrated in FIG. 2.

The geothermal fluid GF comprises geothermal brine GB and a geothermal mixture GM comprising geothermal vapour GV (water steam) and non-condensable gases NCGs. Typically, the non-condensable gases NCGs are almost totally made up of carbon dioxide CO₂ (e.g. 70%-98%) and hydrogen sulphide H₂S (e.g. 0.6%-24%), and to a small extent of other gases (e.g. nitrogen N₂, hydrogen H₂, methane CH₄).

Downstream of the interface zone 13, relative to the flow of the geothermal fluid GF, the geothermal system 2 represented in FIGS. 1 and 2 comprises a separator device 16 configured to separate the geothermal vapour GV and the non-condensable gases NCGs from the geothermal fluid GF. The separator device 16 is, for example, a flash separator or surface-type heat exchanger, known per se. The flash separator consists of a tank into which the liquid supply (geothermal fluid GF) is introduced through an expansion device. The tank has a first outlet 17 at the top for the geothermal mixture GM comprising the geothermal vapour GV and the non-condensable gases NCGs, which is freed of entrained liquid by means of a demister (drop separator), and a second outlet 18 at the bottom for the geothermal brine GB, collected at the bottom of the tank.

The separator device 16 is located in the reinjection line 14, which is thus made up of a first section 14a, which connects the interface zone 13 to the separator device 16, and a second section 14b which connects the second outlet 18 to the reinjection well 15 in order to reinject the geothermal brine GB into said well 15.

The geothermal plant 1 further comprises an expander 19, operatively connected to the first outlet 17 of the geothermal mixture GM (comprising the non-condensable gases NCGs and the steam GV) by the separator device 16, and an auxiliary generator 20 operatively connected to the expander 19. The expander 19 is located downstream of the interface zone 13 where it interfaces with the ORC closed-cycle system 2 so as to receive and expand the non-condensable gases NCGs and the geothermal vapour GV on exiting the separator device 16, i.e. after the geothermal mixture GM has already exchanged heat with the organic working fluid OWF of the ORC cycle.

The expander 19 is connected to the first outlet 17 of the separator device 16 through one or more inlet conduits 21.

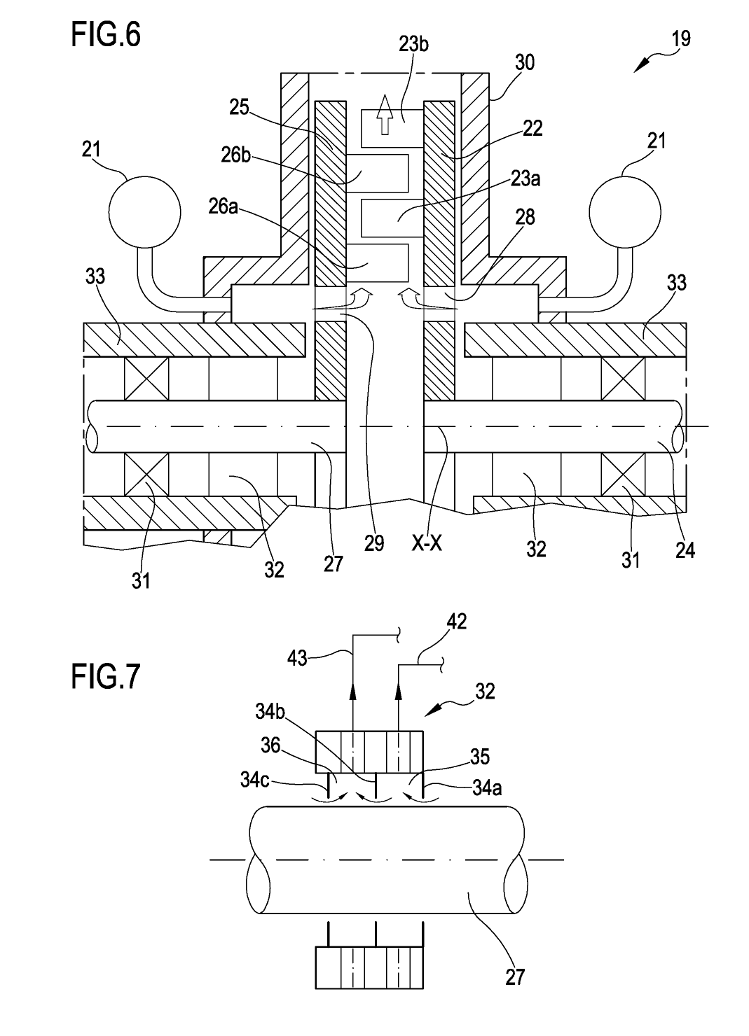

The expander 19 is, for example, a centrifugal radial (outflow) turbine, for example, of the counter-rotating type, such as the one illustrated in FIG. 6. In unillustrated variant embodiments, the expander 19 can be another type of turbine (single-rotating centrifugal radial, centripetal radial, axial, etc.).

The counter-rotating centrifugal radial turbine 19 of FIG. 6 comprises a first supporting disk 22 having a first face bearing a plurality of first radial rotor stages 23a, 23b, each made up of a series of blades disposed in succession along a respective circular path and with a first orientation. A first rotation shaft 24 is integral with the first disk 22. A second supporting disk 25 has a second face bearing a plurality of second radial rotor stages 26a, 26b, each made up of a series of blades disposed in succession along a respective circular path and with a second orientation, opposite the first. A second rotation shaft 27 is integral with the second disk 25. The first disk 22 is facing the second disk 25 so as to delimit an expansion volume and the blades of the first disk 22 are radially alternated with the blades of the second disk 25.

The first and second rotation shafts 24, 27 are connected to a single auxiliary generator 20 or else each to a respective auxiliary generator 20.

Each of the disks 22, 25 has admission channels 28, 29 located in a radially internal position relative to the series of blades of the radial rotor stages 23a, 23b, 26a, 26b. The admission channels 28, 29 are connected to the first outlet 17 of the separator device 16 by means of the inlet conduits 21. The first and the second disk 22, 25 are free to rotate together with the respective shafts 24, 27 about a common rotation axis X-X and rotate in opposite directions under the action of the geothermal mixture GM entering through the admission channels 28, 29.

The first and second supporting disks 22, 25 are housed in a fixed casing 30. The first and second shafts 24, 27 are rotatably supported in the casing 30 by means of bearings 31.

The counter-rotating centrifugal radial turbine 19 further comprises a sealing device 32 (schematically illustrated in FIG. 6) operatively disposed about each of the rotation shafts 24, 27 at the respective supporting disk 22, 25. Every sealing device 32 is configured to prevent the leakage of the non-condensable gases NCGs or of the geothermal vapour GV with non-condensable gases NCGs towards said shaft 24, 27, i.e. in the passage delimited between the shaft 24, 27 and a sleeve 33 that accommodates it.

The structure of the sealing device 32 can be seen in FIG. 7. In this embodiment, the sealing device 32 comprises: three sealing elements 34a, 34b, 34c delimiting two annular chambers 35, 36 disposed about the rotation shaft 24, 27.

A first sealing element 34a is adjacent to the internal volume of the centrifugal radial turbine 19 occupied by the gases. A third sealing element 34c is adjacent to an environment in communication with the outside, i.e. at atmospheric pressure. A second sealing element 34b separates the two chambers 35, 36. A first annular chamber 35 is delimited by the first and second sealing elements 34a, 34b. A second annular chamber 36 is delimited by the second and third sealing elements 34b, 34c.

An ejector 37 is operatively connected to said two annular chambers 35, 36.

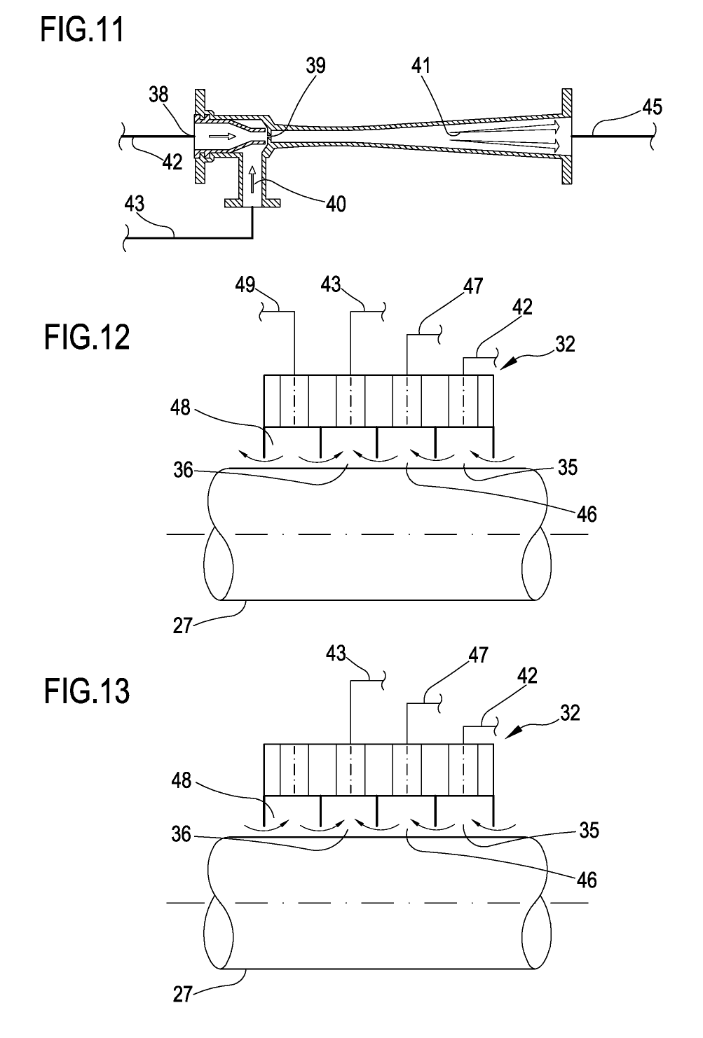

The ejector 37, known per se, comprises (FIG. 11) a motive fluid inlet 38, a nozzle 39 connected to the motive fluid inlet 38, a suction inlet 40, and a diffuser 41.

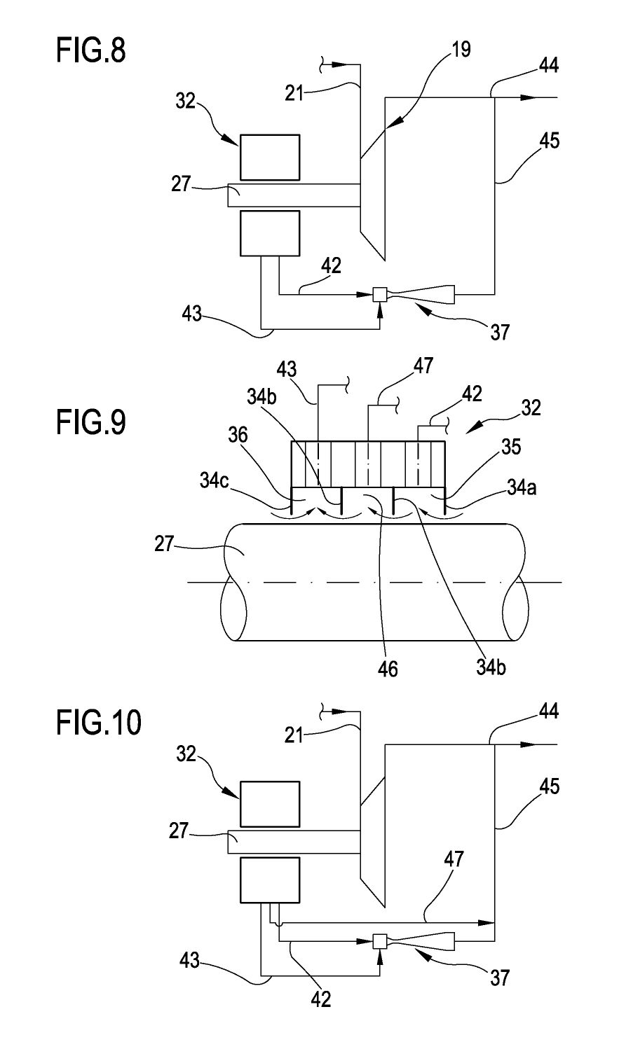

The first annular chamber 35 of the sealing device 32 is in fluid communication with the motive fluid inlet 38 of the ejector 37 by means of a first conduit 42. The second annular chamber 36 is in fluid communication with the suction inlet 40 of the ejector 37 by means of a second conduit 43 (FIGS. 7, 8 and 11). The diffuser 41 is in fluid communication with a discharge outlet 44 of the centrifugal radial turbine 19 by means of a third conduit 45, as schematically illustrated in FIG. 8 (which for the sake of simplicity shows a single-rotating centrifugal radial turbine).

The ejector 37 generates a pressure lower than atmospheric pressure in the second annular chamber 36, exploiting the non-condensable gases NCGs or the geothermal vapour GV with non-condensable gases NCGs present in the centrifugal radial turbine 19. The negative pressure in the second annular chamber 36 draws in air from the outside environment, preventing the leakage of the air and non-condensable gases NCGs it contains. For this purpose, the ejector 37 exploits, as a motive fluid, the non-condensable gases NCGs or the geothermal vapour GV with non-condensable gases NCGs, which pass through the first seal (and are thus present in the first annular chamber 35) so as to draw in a mixture of the gases present, together with the air that has entered from the outside environment, into the second annular chamber 36. This mixture is then introduced into the discharge outlet 44 of the centrifugal radial turbine 19.

In a variant embodiment illustrated in FIGS. 9 and 10, the sealing device 32 comprises a third annular chamber 46 axially interposed between the first annular chamber 35 and the second annular chamber 36. In this case, two second sealing elements 34b delimit said third annular chamber 46. The third annular chamber 46 is in fluid communication with the discharge outlet 44 of the centrifugal radial turbine 19 by means of a fourth conduit 47. In this manner it is possible to improve tightness, thus limiting the amount of non-condensable gases drawn by the ejector 37 into the mixture of air and non-condensable gases present in the second chamber 36.

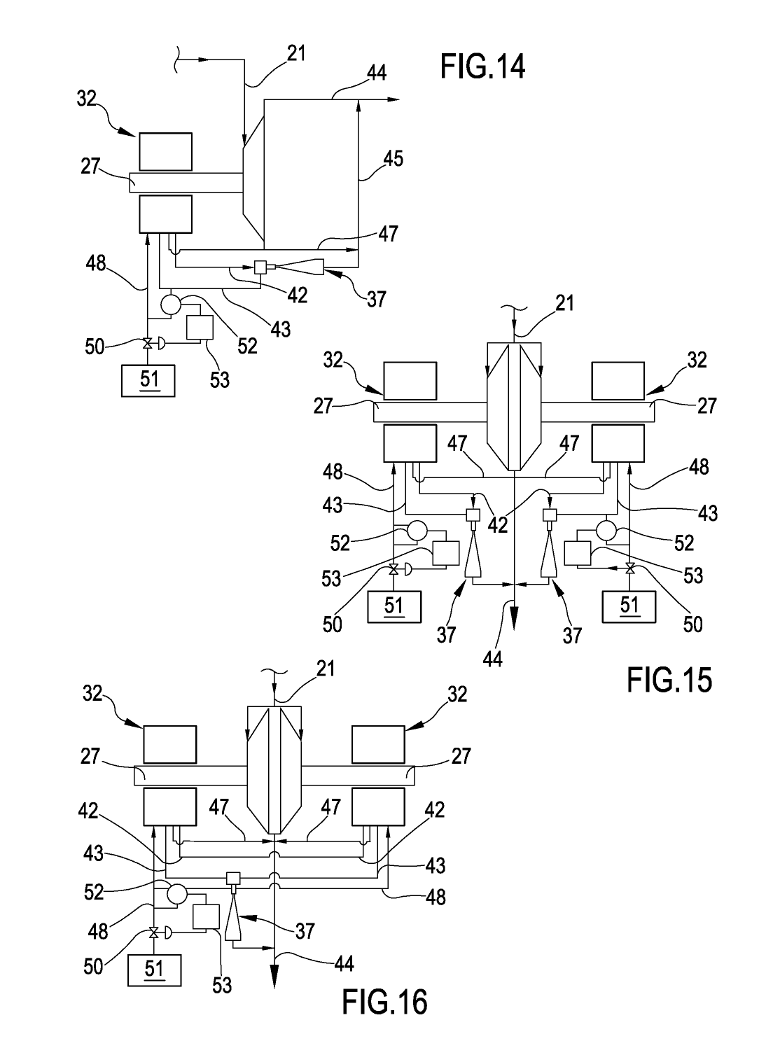

In a further variant embodiment illustrated in FIGS. 12, 13 and 14, the sealing device 32 further comprises an auxiliary annular chamber 48 set between the second chamber 36 and the outside environment, i.e. next to the second chamber 36. Said auxiliary chamber 48 can be selectively connected, by means of a fifth conduit 49 fitted with a proportional valve 50, to a source 51 of gas under pressure (air).

The sealing device 32 of this additional variant embodiment is configured to operate under two conditions. If the motive fluid (non-condensable gases NCGs or geothermal vapour GV with non-condensable gases NCGs) of the ejector 37 is at a pressure such as to be able to create negative pressure in the second chamber 36, the auxiliary chamber 48 will be disconnected from the source of gas under pressure 51 (FIG. 13, valve 50 closed). If the motive fluid of the ejector 37 is at a pressure such as not to be able to create negative pressure in the second chamber 36, the auxiliary chamber 48 will be connected to the source of gas under pressure 51 and will accordingly be at a pressure higher than atmospheric pressure (FIG. 12).

In order to switch automatically from the first condition to the other one it is sufficient to measure the pressure differential between the auxiliary chamber 48 under pressure and the second chamber 36 by means of a pressure sensor 52 and adjust the pressure differential with the proportional valve 50 controlled by a controller 53 (PLC). In this manner, when the turbine 19 enters a phase in which the ejector 37 is able to create a sufficient vacuum, the proportional valve 51 will close so as to avoid using up air pointlessly.

FIG. 15 schematically illustrates the counter-rotating centrifugal turbine 19 of FIG. 6 with the two sealing devices 32 configured as in FIGS. 12 and 13. In the solution in FIG. 15 there are two injectors 37 and two sources of gas under pressure 51 (with a respective valve 50, pressure sensor 52 and controller 53), one for each sealing device 32. In the variant in FIG. 16, by contrast, there is only one injector 37 and only one source of gas under pressure 51 (with a respective valve 50, pressure sensor 52 and controller 53) connected to both the sealing devices 32.

The sealing device 32 with the above-described variants thereof can also be used in expanders/turbines other than the one dedicated to the expansion of non-condensable gases and thus form the subject matter of an independent invention. In use, in accordance with the process of the invention and with reference to FIGS. 1 and 2, the geothermal fluid GF extracted from the geothermal production well 11 passes, in sequence, into the evaporator 4 and into the preheater 9, where it exchanges heat with the organic working fluid OWF and brings about the preheating and evaporation thereof. Subsequently, the geothermal fluid GF, which has transferred heat to the organic Rankine cycle ORC, is introduced into the separator device 16.

The separator device 16 separates the non-condensable gases NCGs and the geothermal vapour GV from the geothermal fluid GF. The non-condensable gases NCGs and the geothermal vapour GV exit from the top, through the first outlet 17, and are introduced into the expander 19. The geothermal brine GB exits from the bottom, through the second outlet 18, and is reinjected underground through the reinjection well 15. The expander 19 receives and expands the geothermal mixture GM comprising the geothermal vapour GV and the non-condensable gases NCGs after it has transferred heat to the organic working fluid OWF of the ORC cycle. The typical inlet thermodynamic conditions of the expander 19 are shown in the following Table 1.

TABLE 1

| | | Min | Max |
|---|---|---|---|
| Pressure | [bar] | 2 | 16 |
| Temperature | [° C.] | 90 | 160 |
| Mass flow rate | [kg/s] | 6 | 20 |
| Volumetric flow rate | [m³/s] | 0.4 | 2.5 |
| H₂O | [% Mass flow] | 2% | 25% |

The typical discharge conditions of the expander 19 are shown in the following Table 2.

TABLE 2

| | | Min | Max |
|---|---|---|---|
| Pressure | [bar] | 0.8 | 1.3 |
| Volumetric flow rate | [m³/s] | 3 | 15 |
| Titer | [%] | 85% | 100% |

With regard to the specific enthalpy change and power, the typical values are shown in the following Table 3.

TABLE 3

| | | Min | Max |
|---|---|---|---|
| Enthalpy change | [kJ/kg-K] | 80 | 200 |
| Power | [kW] | 500 | 4000 |

If the counter-rotating centrifugal radial turbine of the above-described type is adopted as an expander 19, supporting disks 22, 25 of the same will rotate with an angular velocity comprised between about 2000 RPM and about 4000 RPM. The shafts 24, 27 of the counter-rotating centrifugal radial turbine 19 can therefore be connected directly to the auxiliary generator(s) 20 without the interposition of any reduction gear.

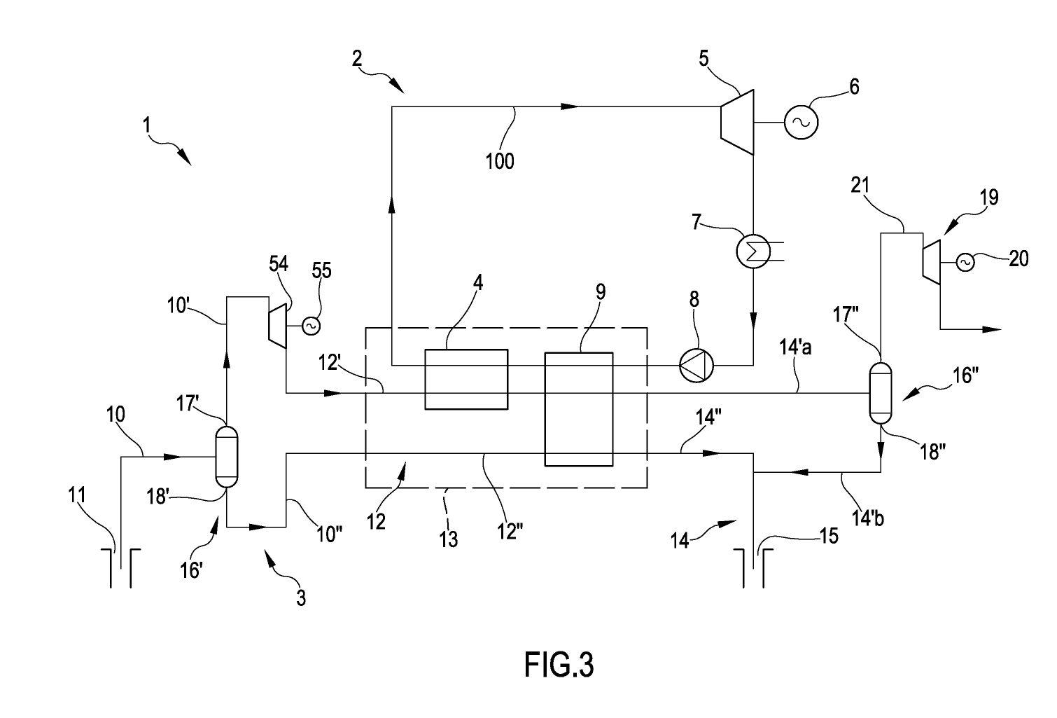

The variant embodiment of the plant 1 illustrated in FIG. 3 comprises a first separator device 16′ positioned upstream of the interface zone 13 and a second separator device 16″ positioned downstream of the interface zone 13. An auxiliary expander 54 is moreover connected to the first separator device 16′, through a first branch 10′ of the intake line 10, and is mechanically connected to an additional auxiliary generator 55. The first separator device 16′ separates the geothermal fluid GF coming from the intake line 10 into geothermal vapour GV with non-condensable gases NCGs and geothermal brine GB.

The geothermal vapour GV with non-condensable gases NCGs exit from the top, through a first outlet 17′, and are introduced into the auxiliary expander 54. In the auxiliary expander 54, the geothermal vapour GV and the non-condensable gases NCGs expand without having first exchanged heat with the ORC cycle, i.e. in the manner according to the prior art. The geothermal brine GB exits from the bottom, through a second outlet 18″, and flows into a second branch 10″ of the intake line 10.

The expanded geothermal vapour GV together with the non-condensable gases NCGs exiting the auxiliary expander 54 flow into a first line 12′ of the interface line 12 through the vaporizer 4 and then the preheater 9 of the ORC system 2 and are subsequently sent to the second separator device 16″, through the first section of a first branch 14′a of the reinjection line 14. The second separator device 16″ has a first outlet 17″ connected by means of the inlet conduit 21 to the expander 19. The second separator device 16″ has a second outlet 18″ connected by means of the second section of the first branch 14′b to the reinjection well 15. The second separator device 16″ separates the mixture of geothermal vapour GF and non-condensable gases NCGs coming from the interface zone 13 (i.e. after it has exchanged heat with the ORC cycle) into a liquid part (condensed geothermal vapour GV) and a gaseous part (uncondensed geothermal vapour GV and non-condensable gases NCGs). The liquid part is introduced into the reinjection well 15. The gaseous part exits through the first outlet 17′ and expands in the expander 19 in the same manner as described above with reference to the expander 19 of FIGS. 1 and 2.

The geothermal brine GB coming from the second outlet 18′ of the first separator device 16′ flows through a second line 12″ of the interface line 12 and through the preheater 9 of the ORC system 2, and then it is introduced into the reinjection well 15 through a second branch 14″ of the reinjection line 14.

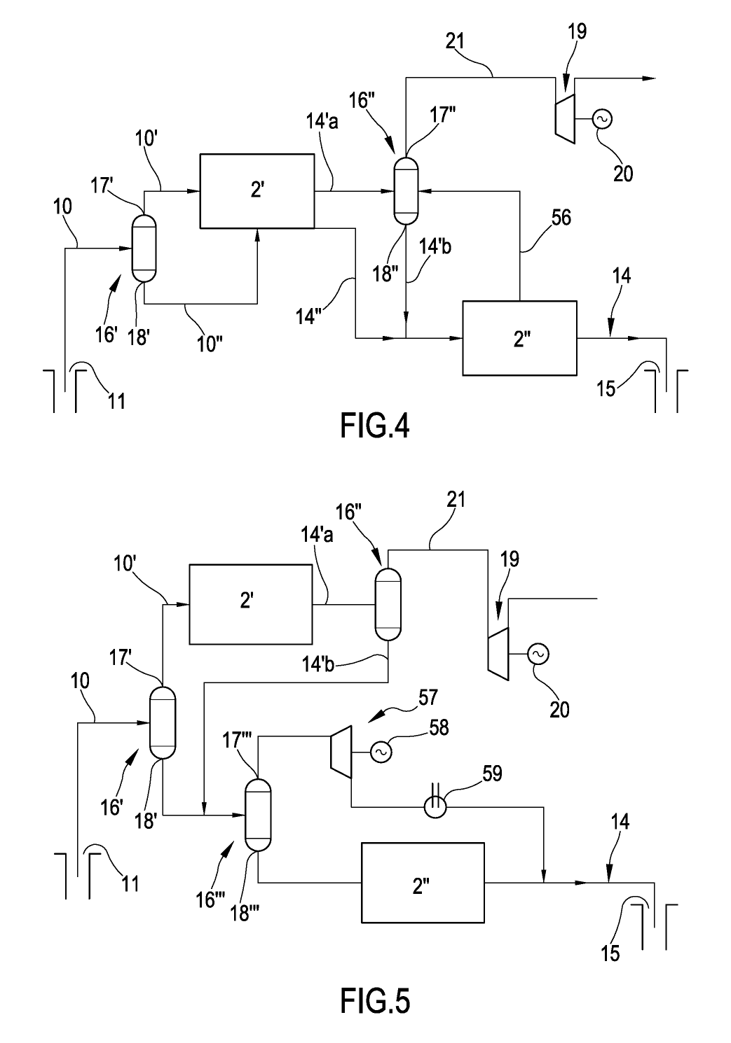

The further variant embodiment of the plant 1 illustrated in FIG. 4 comprises a high pressure ORC closed-cycle system 2′ and a low pressure ORC closed-cycle system 2″ positioned operatively downstream of the high pressure ORC closed-cycle system 2′. The low pressure ORC closed-cycle system 2′ receives the geothermal fluid GF after said geothermal fluid has exchanged heat in the high pressure ORC closed-cycle system 2″.

The first separator device 16′ is positioned upstream of the high pressure ORC closed-cycle system 2′ but no auxiliary expander is present. The geothermal vapour GV with non-condensable gases NCGs which exit from the top through the first outlet 17′ exchange directly heat with the high pressure ORC closed-cycle system 2′ and then enters the second separator device 16″ (which is a reboiler or direct contact heat exchanger) connected to the expander 19. The geothermal brine GB coming from the second outlet 18′ of the first separator device 16′ exchanges heat with the high pressure ORC closed-cycle system 2′ and is then sent to the low pressure ORC closed-cycle system 2″. The liquid part separated in the second separator device 16″ flows into the second section of the first branch 14′b, which joins up with the second branch 14″ before entering the low pressure ORC closed-cycle system 2″. On exiting the low pressure ORC closed-cycle system 2″, the geothermal brine GB is in part introduced into the reinjection well 15, through the reinjection line 14, and in part recirculated, through a recirculation line 56, in the second exchanger 16″ (reboiler) so as to extract heat from the mixture of geothermal vapour GV and non-condensable gases NCGs.

The further variant embodiment of the plant 1 illustrated in FIG. 5 comprises two ORC closed-cycle systems 2′, 2″ which operate in parallel. The first outlet 17′ of the first separator device 16′ is connected to a first ORC closed-cycle system 2′. The geothermal vapour GV with non-condensable gases NCGs which exit from the top through the first outlet 17′ exchange heat directly with the first ORC closed-cycle system and then enters the second separator device 16″ (which is a surface-type heat exchanger) connected to the expander 19. The geothermal brine GB coming from the second outlet 18′ of the first separator device 16′ enters a third separator device 16′″ through the second branch 10″ of the intake line 10, together with the liquid part separated in the second separator device 16″ through the second section of the first branch 14′b of the reinjection line 14. In the third separator device 16′″ a further separation takes place. The gaseous part exiting through the first outlet 17′″ of the third separator 16′″ is sent to a further auxiliary expander 57 connected to a respective generator 58. The expanded gases exiting the further auxiliary expander 57 are condensed in an auxiliary condenser 59 and introduced into the reinjection well 15. The liquid part exiting through the second outlet 18′″ of the third separator 16′″ enters the second ORC closed-cycle system 2″ and exchanges heat with the respective organic working fluid OWF in order then to be introduced into the reinjection well 15 together with the condensed gases coming from the auxiliary condenser 59.

1. An ORC binary cycle geothermal plant, comprising:
at least one ORC closed-cycle system comprising at least:
one vaporizer;
one expansion turbine;
one generator operatively connected to the expansion turbine;
one condenser;
one pump;
ducts configured to connect the vaporizer, the expansion turbine, the condenser and the pump according to a closed cycle in which an organic working fluid (OWF) circulates;
a geothermal system comprising at least:
one intake line for a geothermal fluid (GF) connected to at least one geothermal production well, wherein the geothermal fluid (GF) comprises non-condensable gases (NCGs);
one interface line connected to the intake line and operatively coupled to the at least one ORC closed-cycle system in an interface zone, wherein the geothermal fluid (GF) exchanges heat with the organic working fluid (OWF) of said ORC closed-cycle system;
one outlet line connected to the interface line;
wherein the geothermal system further comprises:
at least one separator device configured to separate at least the non-condensable gases (NCGs) from the geothermal fluid (GF);
an expander operatively connected to an outlet of the non-condensable gases (NCGs) by the separator device;
an auxiliary generator operatively connected to the expander;
wherein the expander is located downstream of the interface zone for interfacing with the ORC closed-cycle system so as to receive and expand at least the non-condensable gases (NCGs) after they have exchanged heat with the organic working fluid (OWF).

2. The plant according to claim 1, wherein the at least one separator device is also located downstream of the interface zone.

3. The plant according to claim 1, comprising a high pressure ORC closed-cycle system and a low pressure ORC closed-cycle system positioned operatively downstream of the high pressure ORC closed-cycle system.

4. The plant according to claim 3, wherein an interface zone of the low pressure ORC closed-cycle system receives the geothermal fluid (GF) after the geothermal fluid (GF) has exchanged heat in the interface zone of the high pressure ORC closed-cycle system.

5. The plant according to claim 4, wherein the expander is located downstream of the interface zone of the low pressure ORC closed-cycle system and/or of the interface zone of the high pressure ORC closed-cycle system.

6. The plant according to claim 5, wherein the at least one separator device is operatively located downstream of the interface zone of the low pressure ORC closed-cycle system and/or of the interface zone of the high pressure ORC closed-cycle system.

7. The plant according to claim 1, wherein an inlet pressure (Pᵢₙ) of the expander is comprised between about 2 bar and about 16 bar.

8. The plant according to claim 1, wherein a discharge pressure (Pₒᵤₜ) of the expander is comprised between about 0.8 bar and about 1.3 bar.

9. The plant according to claim 1, wherein an enthalpy change (ΔH) through the expander is comprised between about 80 kJ/kg-K and about 200 kJ/kg-K.

10. The plant according to claim 1, wherein a percentage of water (H₂O %) in the expander is comprised between about 2% and about 25% of the mass flow (MF).

11. The plant according to claim 1, wherein the expander is a multi-stage counter-rotating centrifugal radial turbine.

12. An ORC binary cycle geothermal process, comprising:
circulating an organic working fluid (OWF) in an organic Rankine cycle (ORC), wherein the organic working fluid (OWF) is heated and vaporized, expanded in a turbine connected to a generator, condensed and again heated and vaporized;
extracting a geothermal fluid (GF) comprising non-condensable gases (NCGs) from a geothermal production well;
operatively coupling the geothermal fluid (GF) to the organic working fluid (OWF) of the organic Rankine cycle (ORC) in order to exchange heat with the organic working fluid (OWF) and heating and vaporizing the organic working fluid (OWF);
discharging the geothermal fluid (GF);
wherein the process further comprises: separating at least the non-condensable gases (NCGs) from the geothermal fluid (GF), and expanding the non-condensable gases (NCG) in an expander connected to an auxiliary generator;
wherein the expansion of the non-condensable gases (NCGs) in the expander is carried out after the non-condensable gases (NCGs) have exchanged heat with the organic working fluid (OWF).
